(19) United States
(12) Patent Application Publication
(10) Pub. No.: US 2010/0325254 A1
(43) Pub. Date: Dec. 23, 2010

(54) METHOD AND ELECTRONIC DEVICE FOR EXECUTING APPLICATION PROGRAM VIA SNAPSHOT FUNCTION

(75) Inventor: Yu-Liang SUN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/538,864

(22) Filed: Aug. 11, 2009

(30) Foreign Application Priority Data
Jun. 23, 2009 (TW) 98121023

(51) Int. Cl. G06F 15/177

(52) U.S. Cl. 709/222

(57) ABSTRACT

In a method for executing an application program via a snapshot function, an electronic device is activated, and the electronic device is connected to a server, wherein a remote image file of the application program is stored in the server, and a snapshot step is performed onto the remote image file so as to obtain a remote snapshot, and a local settings file corresponding to the application program is obtained from the electronic device, and the electronic device can initialize and execute the application program according to the remote snapshot and the local settings file.

### RELATED APPLICATIONS

This application claims priority to Taiwan Application Serial Number 98121023, filed Jun. 23, 2009, which is herein incorporated by reference.

### BACKGROUND

1. Field of Invention

The present invention relates to a method and a device for executing an application program. More particularly, the present invention relates to a method and a device for executing an application program via a snapshot function.

2. Description of Related Art

With the progress of computer operation structure, enterprise computing has gradually evolved from a mainframe structure to a server-based computing structure. Accordingly, the industry has developed various terminal devices such as a rich client or a thin client.

Generally speaking, in a network system of thin clients and a server, each thin client has quite simplified equipment, and is merely equipped with a necessary display device, a keyboard, a computing device sufficiently to achieve the functions of display and communication, and simple application programs, etc. While in an operation, a thin client will transmit a user instruction to the server, and the server will return a result to the thin client after the operation is completed.

Since each thin client does not need to equip with any high-performance processor and storage device, the manufacturing cost thereof is lower. Further, an administer merely needs the server for administrating the respective thin clients, thus advantaging a concentrated management and saving management cost. Thus, the thin client structure has gradually becoming one of the network systems greatly developed by the industry.

With the novel computer technologies continuously presented to the market, the application program stored in each thin client also has to be updated accordingly. A new version of the application program often requires more storage space. However, each thin client is generally equipped with a storage device having smaller storage space. Therefore, the thin clients often do not have enough storage space for storing new versions of the application programs.

### SUMMARY

Hence, an aspect of the present invention is to provide a method and a device for executing an application program via a snapshot function, thereby creating a snapshot of an application program stored on a server, and enabling a client side to execute the application program according to the aforementioned snapshot.

In one embodiment, a method for executing an application program via a snapshot function includes the steps of activating an electronic device; connecting the electronic device to a server, wherein a remote image file of the application program is stored in the server; performing a snapshot step onto the remote image file so as to obtain a remote snapshot of the remote image file; obtaining a local settings file corresponding to the application program from the electronic device; and enabling the electronic device to initialize and execute the application program according to the remote snapshot and the local settings file.

In another embodiment, an electronic device having a snapshot function includes a storage device, a network connection device and a processing device. The storage device includes a settings file block used for storing a local settings file corresponding to an application program. The network connection device is connected to a server via a network connection, wherein a remote image file of the application program is stored in the server. The processing device includes a snapshot module and an application module. The snapshot module is used for obtaining a remote snapshot of the remote image file via the network connection device, and the application module initializes and executes the application program according to the remote snapshot and the local settings file.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a flow chart showing a method for executing an application program according to an embodiment of the present invention; and

FIG. 2 is a functional block diagram showing an electronic device having a snapshot function according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

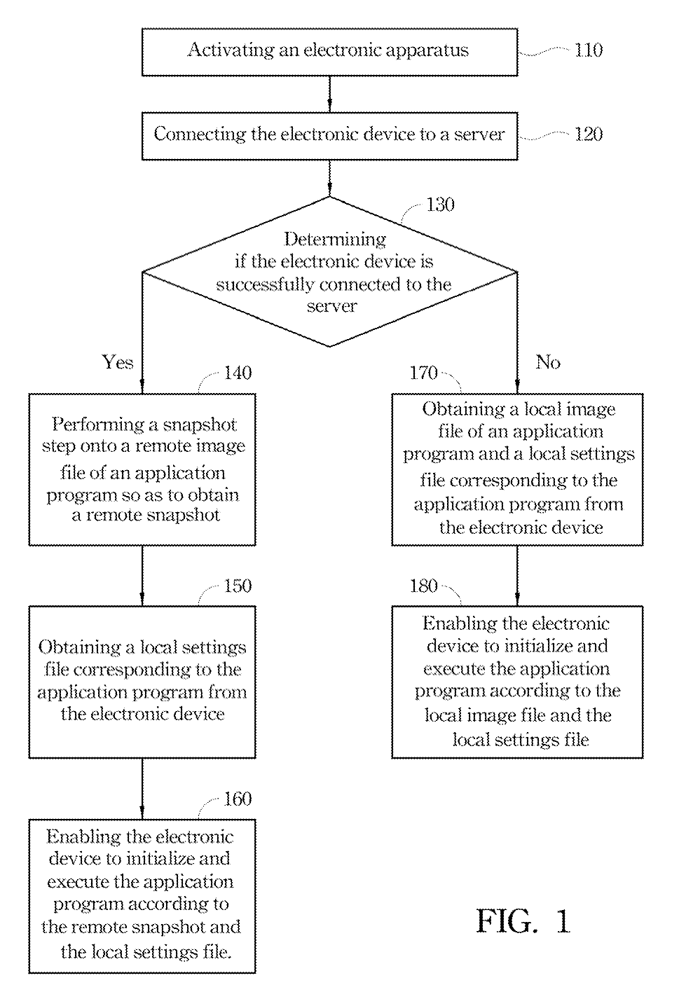

Referring to FIG. 1, FIG. 1 is a flow chart showing a method for executing an application program via a snapshot function according to an embodiment of the present invention. In the method for executing an application program via a snapshot function, a snapshot is taken for an image file of the application program, and is used for initializing a client side and executing the application program. The steps of the method for executing an application program via a snapshot function are described as follows.

After an electronic device is activated (step 110), the electronic device is connected to a server (step 120), wherein there is a remote image file of the application program stored in the server. While the electronic device (client side) is being activated (step 110), a network connection device can be first initialized to establish a network connection between the electronic device and the server (step 120).

In step 140, a snapshot step is performed onto a remote image file of the application program stored in the server, so as to obtain a remote snapshot. In step 150, a local settings file corresponding to the application program is obtained from the electronic device. Thereafter, in step 160, the electronic device can initialize and execute the application program according to the remote snapshot and the local settings file. Thus, only the remote image file of the application program stored in the server needs updating, and thereby the electronic device may execute a new version of the application program via the snapshot function without needing to update the application program stored in the electronic device. In other words, the electronic device does not need additional storage space for storing the new version of the application program.

Further, prior to step 140 of performing the snapshot step onto the remote image file of the application program stored in the server, step 130 is performed to determine if the electronic device is successfully connected to the server. Only when the electronic device is successfully connected to the server, the snapshot step is performed onto the remote image file of the application program stored in the server (step 140).

However, when the electronic device fails to get connected with the server, a local image file of the application program and a local settings file (client side) corresponding to the application program are obtained from the electronic device (step 170). Thereafter, the electronic device can initialize and execute the application program according to the local image file and the local settings file (step 180). Therefore, even if the connection to the server cannot be established, the electronic device still can execute the application program.

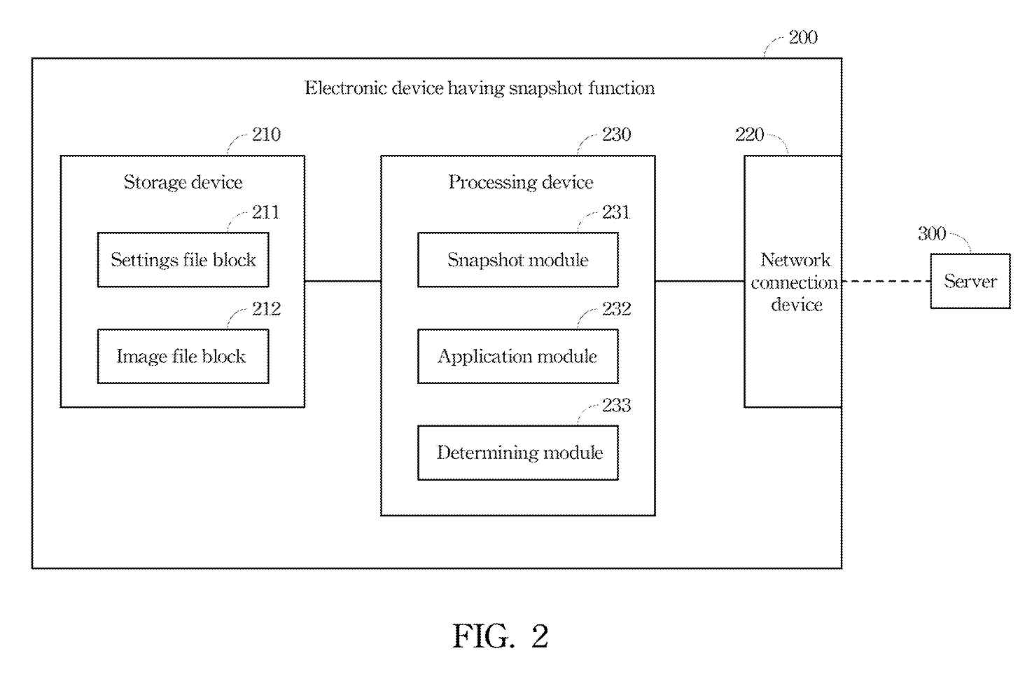

Referring to FIG. 2, FIG. 2 is a functional block diagram showing an electronic device having a snapshot function according to an embodiment of the present invention. The electronic device having a snapshot function creates a snapshot of an application program stored in a server, and executes the application program by using the aforementioned snapshot.

An electronic device 200 includes a storage device 210, a network connection device 220 and a processing device 230. The storage device 210 includes a settings file block 211 used for storing a local settings file corresponding to an application program. The network connection device 220 is connected to a server 300 via a network connection, wherein a remote image file of the application program is stored in the server 300. The processing device 230 includes a snapshot module 231 and an application module 232. The snapshot module 232 is used for obtaining a remote snapshot of the remote image file via the network connection device, and then the application module 232 can initialize and execute the application program according to the remote snapshot and the local settings file. Thus, only the remote image file of the application program stored in the server 300 needs updating, and the electronic device 200 having the snapshot function can execute a new version of the application program accordingly. In other words, the electronic device 200 having the snapshot function does not need additional storage space for storing the new version of the application program.

Further, the processing device 230 may include a determining module 233 used for determining if the electronic device 200 is successfully connected to the server 300 via the network connection device. When the determining module 233 determines that that the electronic device 200 having the snap function is successfully connected to the server 300, the snapshot module 231 performs a snapshot step onto the remote image file so as to obtain the remote snapshot. Thereafter, the application module 232 initializes and executes the application program in accordance with the local settings file and the remote image file.

Further, the storage device 210 may include an image file block 212 used for storing a local image file of the application program. Thus, when the determining module 233 determines that the electronic device 200 fails to get connected to the server 300 via the network connection device 220, the application module 232 can initialize and execute the application program according to the local image file and the local settings file. In other words, when the electronic device 200 cannot be connected to the server 300, the electronic device 200 still can execute the application program by using the local image file stored in the image file block 212.

It can be known from the aforementioned embodiments that the present invention has the following advantages. Only the remote image file of the application program stored in the server needs updating, and thereby the electronic device may execute a new version of the application program via the snapshot function without needing to update the application program stored in the electronic device. In other words, when a new version of the application program is published, the electronic device does not need additional storage space for storing the new version of the application program. Particularly, when the embodiments of the present invention are applied on thin clients each of which has smaller storage space, each thin client can execute the new version of the application program without requiring additional storage space, thus preventing the storage space of the thin client from being exhausted due to constantly updating the application program. Further, when the server cannot be connected, the application program still can be executed by using the image file stored in the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for executing an application program via a snapshot function, comprising:
activating an electronic device;
connecting the electronic device to a server, wherein a remote image file of the application program is stored in the server;
performing a snapshot step onto the remote image file so as to obtain a remote snapshot of the remote image file;
obtaining a local settings file corresponding to the application program from the electronic device; and
enabling the electronic device to initialize and execute the application program according to the remote snapshot and the local settings file.

2. The method as claimed in claim 1, further comprising:
determining if the electronic device is successfully connected to the server, wherein a snapshot step is performed onto the remote image file so as to obtain the remote snapshot when the electronic device is successfully connected to the server.

3. The method as claimed in claim 1, further comprising:
obtaining a local image file of the application program from the electronic device when the electronic device fails to get connected with the server; and
enabling the electronic device to initialize and execute the application program according to the local image file and the local settings file.

4. An electronic device having a snapshot function, comprising:
a storage device, comprising:
a settings file block used for storing a local settings file corresponding to an application program;
a network connection device connected to a server via a network connection, wherein a remote image file of the application program is stored in the server; and
a processing device comprising:
a snapshot module used for obtaining a remote snapshot of the remote image file via the network connection device; and
an application module which can initialize and execute the application program according to the remote snapshot and the local settings file.

5. The electronic device as claimed in claim 4, further comprising:
a determining module used for determining if the electronic device is successfully connected to the server via the network connection device, wherein the snapshot module performs a snapshot step onto the remote image file so as to obtain the remote snapshot when the electronic device is successfully connected to the server.

6. The electronic device as claimed in claim 5, wherein the storage element further comprises:
an image file block used for storing a local image file of the application program, wherein the application module can initialize and execute the application program according to the local image file and the local settings file when the determining module determines that the electronic device fails to get connected to the server via the network connection device.
